(19) United States
(12) Patent Application Publication
(10) Pub. No.: US 2017/0210591 A1
(43) Pub. Date: Jul. 27, 2017

(54) OBLONG CABLE SPOOL

(71) Applicant: AVI INC., Chilliwack (CA)

(72) Inventor: Matthew KENNEDY, Chilliwack (CA)

(21) Appl. No.: 15/185,765

(22) Filed: Jun. 17, 2016

(30) Foreign Application Priority Data
Jan. 27, 2016 (CA) 2919095

(51) Int. Cl. B65H 75/44; B65H 75/28; H04R 1/10; B65H 75/40

(52) U.S. Cl. CPC B65H 75/4473; B65H 75/406; B65H 75/28; H04R 1/1016; H04R 1/1033; B65H 2701/3919

(57) ABSTRACT

The invention is an oblong cable spool with an internal perimeter defining a hollow that is disposable to retain a rigid portion of a device-cable assembly, such as an ear-bud assembly, where the cable can be spooled around a spooling surface, making the combined assembly of spool and device-cable assembly suitable for the compact organization, spooling, storage and transport of a device-cable assembly.

### FIELD

Cable spools for spooling cable and effective organization and storage of rigid portions of device-cable assemblies, for portable or stationary electronic devices.

### BACKGROUND OF THE INVENTION

Users of electronic devices often find that the cables used with them get tangled, whether they are power, audio or data cables, which is compounded when unspooled cable is gathered for transport and mixed with other cables. Tangled cables can lead to knotting and kinking, are less usable in deployment, and can be frustrating and time-consuming to untangle. Untangling can lead to strain on cables that can wear out the cable jacketing and damage the operational portion of the cable.

Ear-buds, being small individual headphones, are particularly susceptible to tangling as the ear-bud assembly is generally comprised of two independent audio playback portions and an audio jack, each of which is at the end of a very flexible cable portion of the unstructured assembly, and therefore the three portions tend to tangle when gathered or stored without a means to keep the portions from tangling.

Cable spools exist for spooling cables in a compact, organized fashion to keep them from tangling and make them easy for transport. Spools have a long history in storing and maintaining long lengths of thread, rope and chain in an organized manner from which they can be unspooled to great lengths without risk of tangling.

Some cable spools have been fashioned to retain relatively large, inflexible portions of electronic devices fixed to relatively thin, flexible cables to keep them organized and prevent tangling. For example, Apple Inc. has a proprietary spool for organizing the EarPod™ ear-bud assembly, where customized cavities are disposed to retain ear-buds and the volume switch of the assembly, as well as a spooling surface for the cable. As the cavities are specialized to retain a particular rigid portion of the ear-bud assembly, the spool cannot be used for other devices not intended for it. The specialization of the cavities poses limitations to its use, and prevents all other device-cable assemblies from being effectively used with the spool, if at all.

The rise and growth of use of portable electronic devices such as cellular phones, smartphones, audio playback devices, tablets, laptops and other portable computing devices has made cable management an important and ongoing issue in the daily lives of many people. Accessories with electronic devices include ear-buds, headphones, headsets, power cables and data cables. Industrial use of portable electronic devices such as surveying equipment, GPS devices, audio, video and photographic equipment used in film, television, print and web production, and environmental testing equipment also experiences the same issues. People that frequently travel, or transport electronic devices between home and work, or between office and field work, necessarily transport many cables for their various electronic devices and would benefit from portable cable organizational spooling devices.

### SPECIFICATION

The invention is a nominally oblong cable spool with a central perimeter defining at least one interior hollow disposed to retain a portion of an electronic device comprised of a cable and at least one rigid portion (or rigid body), by fitting the rigid portion within the hollow. The interior hollow is sized and shaped to be disposed to receive a variety of rigid portions of cabled electronic devices. The cable portion may be spooled around the spooling portion of the cable spool prior to or post insertion of the rigid portion to the interior hollow. The rigid portion may be fixed within the interior hollow by way of friction fit, and is generally held at opposing sides of the rigid portion within the hollow at the interior perimeter, parallel to the linearity of a cable extending from the rigid portion. The cable spool generally has sidewalls that extend distally from the spooling surface to retain the cable within during spooling.

The interior hollow is sized and shaped to be disposed to receive a variety of rigid portions of cabled electronic devices. The interior hollow, therefore, provides means to retain a rigid portion of an electronic device accommodating a certain range of sizes, being widths, lengths, thicknesses or diameters, and shapes, by being generally non-specific in shape to any particular electronic device portion intended to fit within the interior hollow. Many electronic device carriers have holders shaped to fit the particular device they are intended to carry, but thereby limit the insertion of other devices not-intended; this creates a dilemma to the user who wishes to use the carrier for other devices, rather than the one intended by the manufacturer. Therefore a device-non-specific retaining portion, in the form of an interior hollow with a simple shape, provides an increased opportunity to place a variety of electronic devices or portions of them within the retaining portion. Variations with differing sizes of retaining portions defined by differing sizes of interior hollows provides means to accommodate a greater variety of electronic devices. While portions of electronic devices may fit loosely within the interior hollow, preferred embodiments feature a friction or under-cut fit to retain the electronic device portion, within the retaining portion.

The interior hollow defining the retaining portion is shaped in a non-specific manner, but is capable of retaining a wide variety of rigid portions of cabled electronic devices. The interior hollow is generally shaped in an elongated form in plan view of the cable organizer, similarly to a rectangle in form. As cabled electronic devices are generally linear in composition, the nominally linear, elongated shape of the interior hollow suits their composition. Therefore, the same retention portion of a single embodiment may accommodate ear-buds of different sizes and shapes, USB plug-ends, ferrites an other other rigid portions of cabled electronic devices, which are each within a range of dimension accommodated by the retention portion. Other embodiments with retention portions of different sizes can retain the rigid portions of other sized electronic devices, for example a larger spool with a larger interior hollow intended to retain the plug or ferrite of a monitor power cable, while similarly retaining a power bar of similar width dimension at another instance.

In one embodiment, a digital camera data cable is generally comprised of a plug-end, from which a cable extends, with a ferrite in close proximity to the plug-end, with a further, lower length of cable extending from the ferrite to a distal plug-end. The retaining portion would be fashioned to receive the first plug-end and the ferrite within the interior hollow, after which the long distal cable may be spooled around the spooling portion, where it is fixed in place by retaining the distal plug-end to a retaining feature, such as a slot in the sidewall of the cable spool. A long, linear interior hollow provides a means to retain both the proximal plug-end and the ferrite in proximity to it, features that generally confound the spooling of such cables with rigid portions along it length. Therefore, this embodiment discloses a means to provide spooling and organization of cables that have ferrites or other rigid portions along the cable's length that normally are unsuited for spooling around conventional spools.

As the ends of the spooling portion is semi-circular in form, so may the ends of the interior hollow be, such that the retaining portion is ‘stadium’ shaped or ‘pill’ shaped. The rounded ends at either end of the retaining portion better facilitate the retention of a pair of nominally round ear-buds by providing circumferential retention through friction or under-cut cavitation.

A single channel-shaped interior hollow may also be fashioned to retain a variety of ear-bud types and shapes, including the original Apple ear-buds, Apple EarPods, as examples of those that are retained in the cavum of the external auditory meatus by the tragus and antitragus just exterior of the entrance of the ear canal, and those that fit into the ear canal itself, such as those offered by Beats, Monster, Skull Candy, Sony, Pioneer, Panasonic, Sharp, Aiwa and others.

An undercut may feature, in the form of a recess, such as a groove or cavity, along a portion of the interior hollow, allowing the rigid portion of the electronic device to be inserted into recess within the hollow and be retained fixedly therein, in the manner of a snap-fit feature to provide a superior means of retention. A certain measure of deflection is required by the spool to fit and remove the rigid portion within an undercut groove at a perimeter of a hollow, and therefore flexible material like silicone or elastomer is preferred, though harder injection molded plastic such as PP, ABS, PC or even impact-modified acrylic with enough plasticity to provide adequate flex are also suitable.

A stadium shaped cable spool with a channel shaped interior perimeter defining a hollow with rounded ends and featuring a circumferential recess is a preferred embodiment for retaining ear-buds and other rigid portions of cabled electronic devices. The interior perimeter functions as a retaining portion for a wide variety of rigid portions of electronic devices, such as ear-buds, plug-ends, and ferrites, and is facilitated further by the undercut provided by the recess that is disposed around the circumference of the interior perimeter. The relatively long channel-shaped interior perimeter provides a retaining portion that accommodate a wide variety of rigid portion lengths, a plurality of rigid portions, and their shapes. The width of the interior hollow is sized to provide a friction fit for particular device widths, and the recess provides a secondary retention means for slightly larger or irregularly shaped rigid portions, and the plasticity or elasticity of the cable spool in general provides flexing to accommodate a range of sizes or tolerances.

Differing rigid portions may be inserted and retained in different ways. For example, a single cable spool embodiment may retain Apple EarPods within the recess feature described, where the EarPods are retained by the undercut provided by the recess at opposing ends of the EarPods; similarly, Apple ear-buds, being completely circular in shape where they fit into the ear cavum, may fit within the semi-circular recess at the rounded end of the interior hollow; the same device could retain a round ferrite, where portions of it are pushed into the hollow and retained by the undercut of the recess, or a USB plug-end, that could be held at the interior perimeter by friction fit.

Both the interior perimeter and recess may offer some variation in width between two sides of the cable spool to offer a varying degree of distance for differing sized rigid portions of electronic devices. Preferred embodiments would provide narrowing in the direction of where a cable extending from the rigid portion is positioned to enter the spooling gap and be spooled around the spool. This narrowing provides a physical wedge feature that will aid in retaining the rigid portion, as the rigid portion can be draw to seat against the wedge as the cable is pulled into the gap, through a slot or slit at the interior perimeter, and spooled around the spool, fixing the rigid portion in place by the friction and mechanical lock the spooled cable provides.

A connective portion between the interior hollow and the spooling surface is generally a slot, slit or channel, and may generally be at an extremity of the hollow, or in the middle, or a combination of these, depending on function and purpose or in view of universality. Where a narrowing wedge portion of an interior perimeter, hollow, and recess exists, it would generally narrow in the direction of the connective portion, or cable exit slot, so that tensioning a cable attached to a rigid portion would draw the rigid portion against the wedge, providing a friction fit. This retention means is further aided by a bump at the interior perimeter or recess that would deform a portion of the cable spool as the rigid portion is drawn past it, and would relax once the rigid portion has passed, providing an added mechanical retention means.

A radius or chamfer at an interior perimeter at an entrance to the hollow provides a funnel shape to facilitate inserting a rigid device therein, particularly into a recess thereat.

A preferred embodiment of the invention to appear simple in design is an oblong ‘stadium’ shaped spool with two parallel flats sides joined at either end by a rounded semi-circular portion of the spool, a description matched by the interior hollow and groove of the spool, to make a unitary channel defined by an interior perimeter of the spool. An embodiment as described appears simple in design and yet accommodates a broad assortment of rigid portions of various electronic devices and their cables by being non-specific in design. Different sizes of the embodiment as described offer retention of different sized rigid portions and their associated cables.

The embodiments as described are in contrast to cable spools that have recesses shaped to fit specifically the shape of a specific rigid portion of a cabled electronic device; such existing art prevent the possibility of inserting and retaining devices not intended to fit the recess specifically.

Embodiments intended to organize and spool ear-buds may feature a central hollow disposed to receive an earbud and retain it therein by friction, or within a secondary under-cut groove thereat. A single hollow may retain both earbuds, or a secondary hollow may be disposed to retain a secondary earbud.

Preferred embodiments to spool and organize ear-bud cable assemblies feature a flat, oblong spool where a single central hollow retains each of two ear-buds at opposing ends of the hollow, retained within a recess within an interior perimeter defining the hollow. The ear-buds are inserted in a minor-image fashion at opposing ends of the hollow, placing the rounded part that fits into the ear into the rounded ends at opposite sides of the hollow. The cables extending from each ear-bud once inserted orient toward the center of the spool and hollow, where a slot in the wall of the spooling surface provides access from the hollow to the spooling surface, where the cables are inserted through such that the cables may be spooled around the spooling surface around the hollow and around the ear-buds retained within it. The ear-buds are placed in parallel in the preferred embodiment rather than being stacked on top of each other, to avoid large and bulky spools that are more difficult to store into a tight space such as a pocket; the preferred embodiment holds the ear-buds side-by-side in a linear fashion, organized on a single plane, at opposing ends of the interior hollow, and is able to be designed flat and easy to store in compact spaces. By bringing the two cables of the two ear-buds together at the center, to pass together through a slot to the spooling surface, they may be spooled together around the spool at equal lengths and therefore even and complete spooling without extraneous cable left unspooled from a cable being longer than the other.

Earbuds may be inserted into a recess around the interior perimeter defining the hollow central to the spool. The recess effectively is an undercut cavity where, once an ear-bud is pushed into the cavity, the ear-bud is retained by being retained by the interior perimeter where it forms an undercut at the point where it joins the recess. Embodiments as described rely on a degree of deflection of the material of the interior perimeter, so that spools comprised of flexible material, especially elastomers or silicones, facilitate the flexing and are desirable for use in the manufacture of such spools.

Embodiments may feature a wedge shape to a portion of the interior hollow to facilitate retaining a rigid portion through friction or within an undercut. Portions of the interior perimeter may be fashioned as a narrowing wedge toward a slot that a cable extending from a rigid portion would pass through. A rigid portion may pass easily into a portion of the hollow, being smaller in size than a portion of the aperture of the hollow. As the cable is drawn through the slot, however, the rigid portion is drawn to a narrower portion of the wedge, where it would become lodged either by friction, against the wedge-shaped interior perimeter, or within an undercut within the wedge-shaped interior perimeter where it would become mechanically locked in place. An interior perimeter may form a lip over a recess to prevent the rigid portion from being retracted out of the hollow by any means other than being drawn out of the wedge, once cable is loose to permit free movement of the rigid portion. The cable may then be spooled around the spooling surface, effectively locking the rigid portion it is attached to in place by first tensioning the cable and then restraining portion proximal to the rigid portion by the spooling action.

The angled interior perimeter of the wedge permits rigid bodies of different sizes to be retained within the interior perimeter, as the width variation of the wedge may accommodate different widths; a rigid portion will stop against a position on the interior surface where its width matches the width between the sides of the wedge, allowing for some deflection of material.

Likewise, embodiments may feature a wedge-shaped recess to add a measure of friction tensioning for rigid bodies drawn into and against the recess.

Bumps protruding from the interior perimeter or recess also provide a physical obstacle to prevent further travel of a rigid portion within the hollow as it is drawn by a cable and tensioned. By placing tension on the cable, the rigid portion can be fixed against a bump, and spooling the cable around the spooling surface will provide a measure of retaining the rigid portion in place against the bump. A bump on each side of the hollow provides a balanced measure of restraint.

Where two rigid bodies, such as a pair of ear-buds, are used, an embodiment of the spool may feature an interior perimeter with two wedge portions, at opposing sides of the hollow. As described above, preferred embodiments for ear-buds draw and pass cable from either end through a central slot. Therefore, the wedges would narrow toward the center in preferred embodiments; as the cables from the two ear-buds are drawn to the center, they will be retained by their respective wedges, and the cable may be drawn through the slot and spooled, restraining the rigid bodies within the hollow.

Embodiments of cable spools with flat sides also facilitate the spooling of cable with a second rigid portion along the length of a cable portion, such as the volume switch portion of an ear-bud assembly. Ear-buds with volume switches generally are comprised of a first cable portion extending from a nominally rigid earbud to a rigid volume switch, from which a second cable portion extends to a central hub, wherefrom a third cable portion ultimately extends to a rigid audio jack. A second ear-bud is typically joined to the hub of the ear-bud assembly by a fourth cable portion. Once the earbuds are inserted into a hollow (or hollows) at an interior perimeter, the remaining cable is fitted through a slot in a sidewall to be able to be spooled around the spooling surface of the spool. The flexible cable portions are able to bend around curved portions of the spool, but the rigid volume switch is unable to seat against a narrow curved portion of the spool, and would cause strain to the cable extending from it. Therefore, the embodiment as described features flat sidewalls along a portion of the spool to seat a rigid portion of the assembly, such as a volume switch, the flat linear portion of the spool accommodating the flat linear shape of the rigid portion in line with the cable. Embodiments with parallel flat sidewalls provide a desired ambiguity so that the cable may be spooled in either direction such that the second portion may be seated against a flat portion regardless of the direction of spooling.

A single interior channel of the spool has the aesthetic advantage of appearing simple and uncomplicated, and can be used without a rigid portion inserted therein without appearing unused. The relatively large void delineated by the oblong interior perimeter also appears to lessen to physical presence of a cable spool, despite embodiments being of large size, and the void presents opportunity for fingers to grip the spool therein, making handling of the spool easier.

When a spool is part of a family of spools wherein each are designed to fit different sized rigid portions, the family collection has the aesthetic advantage of appearing of the same general design without obvious variations of the central interior perimeter. Each would have the same basic design of an oblong central perimeter, regardless of the size of device each was designed to retain.

The invention is generally to be made from hard or elastomeric injection molded plastics or silicones. Elastomers, like silicone, provide an advantage over hard plastics or other hard materials in that the internal perimeter dimension can be made slightly smaller than a dimension required to retain a rigid portion so that the rigid portion compresses the elastomeric material during insertion to allow better retention through compression. This also provides greater allowances for tolerance in the dimensions of the cable spool and the adaptor. Elastomers, especially silicones, also allow other features to be more easily molded, such as flexible portions intended to allow entry of a cable and retaining them therein, and undercuts, than conventional plastic injection molding. Elastomers, especially silicones, generally have excellent dielectric properties. Silicone, in particular, is advantageous in that it is generally heat and fire resistant (having high temperature ratings), which is suitable for use with electrical equipment in unpredictable environments, and also has low compression set properties unlike most thermoplastic elastomers.

Where a rigid portion is smaller than the spool's internal perimeter, it may be loosely placed inside the internal perimeter during storage. If the rigid portion also has a cable extending from it that is wound around the spool, then the rigid portion is effectively, if loosely, supported by the spool.

Embodiments may feature slots, slits or holes in the sidewalls, the interior perimeter or other portions of the spool to provide means to pass a cable through and hooking the cable into place either prior or after spooling. Likewise, embodiments may feature flanges to retain cables or plugs around the perimeter of the spool. Some embodiments may feature discreet flanges around a perimeter of a spool's distal sidewall to retain a portion of the cable without necessitating passing the cable into or out of a retention flange imposing friction on a cable that surrounds the entire circumference of the spool, which, as disclosed herein, would cause undo strain to the jacketing of a cable.

Relief slots in the sidewalls may also be used to insert or exit an end of a cable into or from a cable spool. As a cable is spooled or unspooled on a cable spool, it may be hooked at a selected unspooled cable length into a slot. Employing a number of slots permits a greater selection of cable lengths left unspooled for deployment in use or storage, however a circular array of three slots on a sidewall is generally sufficient to prevent redundancy and lessening the integrity of the sidewall. Elastomeric materials benefit the design by permitting the use of a flexible portion of the material at a slit in a sidewall to retain the cable within the slot, the entranceway to the slot being a slit narrower than the cable but, being flexible, the material of the sidewall can be flexed open at the slit to allow entry of the cable therein to the slot.

A portion of the spool around a cable slot also benefits inserting and retaining a cable by having a narrowing of the material of the spool closer to the slot so that the cable requires less bending to enter or exit the slot, the thinness of the there material around the slot also making the portion more flexible to accommodate pressures influenced on it by the cable.

Embodiments may feature cord-plug retention means that are in-line with the manner of spooling, retaining the plug-end of a cord within a gap between the sidewalls of a spool to prevent a plug-end from extending distally or laterally from a sidewall of the spool that would be anaesthetic and difficult to store compactly.

An interior portion of the cable spool between the sidewalls may have a portion defined by flanges extending from or a slot within a sidewall to retain a plug-end of a cable therein to hold the cable prior to spooling so that the cable is gripped to prevent the plug-end from just spinning around and preventing spooling during the act of moving the cable around the spool.

In some embodiments, a flange or flanges extends interiorly from a sidewall or sidewalls of a cable spool so that a cord can be inserted between the flanges and its plug-end is drawn toward the flanges where it becomes fixed in place prior to spooling. This allows one hand to hold the spool, the other to draw and spool the cable, while the retention flanges holds the cable.

Likewise, in other embodiments, a recess is disposed to receive a plug that can be pushed into the recess by hand or with another device, such as using an opposing plug-end of a cable to push the other plug-end into the recess. In yet another embodiment, a slot in a portion of the interior perimeter allows a plug-end to be inserted and retained prior to the cable being spooled around. The benefit of each of these three variants over hooking the cable through a slot in a sidewall is that the retained plug-end doesn't extend beyond any perimeter of the spool that would make it thicker, being aesthetically unappealing or more difficult to insert into a compact space for storage.

Embodiments may feature plug retention means at a distal perimeter of a spool between sidewalls of the spool. Once the cable is nominally spooled within the sidewalls of the cable spool, a distal plug-end may be inserted between the sidewalls to retain it by friction or pressure fit. An added lip or flange at an interior portion of the sidewall, such as around the interior portion of the distal perimeter of the sidewall, may be disposed to retain the thick plug-end, such as a USB plug, without obstructing the spooling of a thinner cable around the spool, as the plug-end is larger than the cable and the lip or flange is intended only to hold the plug by retention or friction and not to obstruct the movement of the cable.

In those embodiments where both plug-ends are fastened to a spool between planes defined by the sidewalls of the spool, then the complete assembly of the cable and spool is considered to be flat and compact and easier to store in compact, narrow spaces such as pockets or sleeves. In such embodiments, where both plug-ends of a cable are connected to a spool by features between the sidewalls, holes or slots for hooking and retaining cable is unnecessary.

Embodiments may feature a plug retention flange on an interior portion of a sidewall, effectively narrowing the gap between sidewalls of the spool. A plug retention flange may retain a plug by making a gap between the flange and the spooling surface that the plug may be drawn into and trapped, or effectively narrow the width between the sidewalls where the plug would incur friction thereat and therefore be retained. Preferred embodiments feature plug retention flanges on the interior portion of both sidewalls of a spool adjacent to the distal perimeter of the sidewalls, effectively narrowing the spool at the aperture to the gap into which cable may be spooled. The large space within the spooling gap allows cable to be freely spooled, and where the cable is spooled to the point where the distal plug comes into contact with the spool, it may be force between the plug retention flanges that hold it therein by friction. This may be facilitated by making the flanges of a deformable elastomeric material, especially so if that material is gummy or sticky. Some deflection of a sidewall also imposes a force on the plug to retain it further, so the aperture between a flange and sidewall or between flanges may be manufactured narrower than the actual thickness of the plug intended to be retained therein.

The flat, oblong, compact design of preferred embodiments permit the spool to be stored in tight, narrow, compact spaces such as a pocket, and shipped inexpensively, especially if the thickness, with packaging, is kept within the maximum allowable thickness allowed for regular letter mail. The oblong design permits rigid portions of device-cable assemblies along a linear length of cable to fit within the hollow prior to spooling of cable. A rigid portion thus retained within the hollow may be at the terminus or along the length of a cable.

The design of preferred embodiments of the invention aim to provide a high level of utility in the simplest design, and therefore the featurism of the spool shows a high degree of complexity concealed within the apparently simple form of a single part. The features of such embodiments provide a myriad of applications, while being intuitive in use and aesthetic in its simplicity of form.

The cable spool may be integrated within other products, such as a power-bar, blender, lamp or other household appliance, GPS device, battery, or other portable or fixed devices, to comprise a discreet or integral component of the assembly.

The term cable as used herein is synonymous with wire, cord and the like. The term cable spool is synonymous with cable organizer and the like. The term rigid portion is synonymous with the terms electronic device, plug, ear-bud, ferrite, jack, volume switch, control, power adaptor, power block, power device, charger and the like, and may be substituted by the term of any object attached to a cable if purpose dictates usefulness. The terms slot and hole may be used interchangeably; the terms recess and channel may be used interchangeably. The term radius may be substituted by the terms notch or chamfer, where the purpose of the radius is to provide relief or avoid obstruction. The term Figure may alternatively be termed FIG.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a first embodiment of a cable spool used in conjunction with a device-cable assembly in the form of an ear-bud assembly, with rigid portions represented by ear-buds, showing a nominally oblong, flat cable spool with a stadium-shaped interior perimeter defining a hollow and a slot in a sidewall, conveying access for cables through the slot from the interior perimeter to a more distal spooling surface between sidewalls of the spool.

FIG. 2 is a detailed perspective view of the first embodiment of cable spool illustrated in FIG. 1, showing a closer view of the spool and partial view on the ear-bud assembly, with an ear-bud on the left-hand side in a position above the spool prior to insertion within the hollow, and an ear-bud on the right-hand side inserted within the hollow.

FIG. 3 is a perspective view of the first embodiment of cable spool illustrated in FIG. 1, with both ear-buds shown inserted into the hollow, with the cables passed through the slot in the sidewall where they are partially spooled against the spooling surface.

FIG. 4 is an alternative perspective view of the first embodiment of cable spool illustrated in FIG. 3, shown with the entire cable assembly of the ear-bud assembly spooled around the spooling surface, where the terminating distal plug is passed through a flexible slit into a slot, retaining the distal plug and preventing unspooling of the cable and release of the ear-buds.

FIG. 5 is a top elevation view of the first embodiment of cable organizer illustrated in FIG. 4.

FIG. 6 is a side elevation view, in section, of the first embodiment of cable organizer, taken along section lines A-A of FIG. 5, showing an ear-bud retained within an undercut recess around the interior perimeter that defines the hollow.

FIG. 7 is a top view of a first embodiment of cable spool, shown with an alternative device-cable assembly in the form of a USB data cable with rigid portions in the form of a ferrite and plugs in the form of USB plugs, showing a ferrite along a portion of the cable assembly, showing a first proximal plug and ferrite retained within the hollow, a cable portion exiting the hollow via a cable exit slot, where a second, distal plug is inserted between a pair of plug-retention flanges between sidewalls within a gap that defines a spooling cavity, prior to the cable being spooled in its entirety; the cable is shown unspooled for clarity.

FIG. 8 is a section view of a first embodiment of cable spool, taken along section lines B-B of FIG. 7, showing the ferrite retained within the hollow partially within the recess and gripped by the interior perimeter at the undercut formed by the recess, and showing the distal plug retained within the gap between plug retention flanges extending proximally from either sidewall within the gap.

FIG. 9 is a perspective view of a second embodiment of a cable spool, shown with a distinct interior perimeter formed with two wedge shaped portions over a recess featuring bumps within it.

FIG. 10 is a top view of the second embodiment of FIG. 9.

FIG. 11 is a side view of the second embodiment of FIG. 9.

FIG. 12 is a section view of a second embodiment of cable spool, taken along section lines C-C of FIG. 11, showing an interior view of the hollow and showing a iconographic depiction of a first rigid portion imaged as a black circle identified as 62M in a first step, shown smaller than an interior perimeter and therefore able to pass within the hollow, and a second step of the first rigid portion identified as 62N showing the rigid portion wedged between the wedge-shaped interior perimeter, exacting a mechanical friction force on the rigid portion as it is drawn by a cable (not shown) fastened to it toward a central slot, and a second rigid portion imaged as a black circle identified as 620 in a first step, shown smaller than an interior perimeter and therefore able to pass within the hollow, and a second step of the second rigid portion identified as 62P showing the rigid portion wedged against bumps within a recess distal of the interior perimeter, the bumps exacting a tensioning force on the rigid portion as it is drawn by a cable (not shown) fastened to it toward a central slot, and retained within an undercut formed by the interior perimeter and the recess.

### TERMS

The following terms are referenced in the drawings and written application:
30 cable spool
32 interior perimeter
34 hollow
36 recess
36A rounded recess end
38 spooling surface
38A round spooling surface
38B flat spooling surface
40 gap
42 sidewall
44 distal perimeter
46 slot
46A cable exit slot
48 slit
50 radius
52 plug retention flange
54 interior perimeter slot
56 wedge
57 undercut
58 bump
60 cable
60A first cable portion
60B second cable portion
60C third cable portion
60D fourth cable portion
61 device-cable assembly
62 rigid portion
62A ear-bud
62B volume switch
62C audio jack
62D proximal plug
62E distal plug
62F ferrite
62G cable assembly joint
62M first rigid portion first position
62N first rigid portion second position
620 second rigid portion first position
62P second rigid portion second position
64 rigid portion perimeter
66 ear-bud arm

### DETAILED DESCRIPTION

A cable spool generally identified by reference numeral 30, will now be described with reference to FIGS. 1 through 12.

### Structure and Relationship of Parts:

A cable spool 30, as depicted in FIGS. 1 to 8, features a nominally oblong interior perimeter 32 defining a hollow 34, shown as ‘stadium’ shaped for functional and aesthetic purposes, separated from a nominally oblong spooling surface 38 by the material wall thickness of the spool 30; the oblong spooling surface 38 is shown as ‘stadium’ shaped with long flat spooling surface 38B portion and a round spooling surface 38A portion at either end. Sidewalls 42 extend distally from the spooling surface 38, having a distal perimeter 44 generally oblong in design, shown as a ‘stadium’ shape for functional and aesthetic purposes. Between sidewalls 42 is a gap 40 into which cable 60 can be introduced and spooled around the spooling surface 38, the sidewalls 42 retaining a cable therein gap 40 defining a spooling cavity.

Preferred embodiments have sidewalls 42 that are nominally parallel to each other to maintain a flat, compact design. Preferred embodiments also feature a radius 48 between the interior perimeter 32 and a sidewall 42 for functional and aesthetic purposes described in the ‘operation’ section of this application.

Embodiments also feature a slit 48 in sidewall 42 providing access of a cable 60 to a position within a slot 46, the material of sidewall 42 being elastomeric so as to deform at slit 48 to allow access of the cable 60 therethrough, where it is considered fixedly retained therein slot 46. Multiple slits 48 and slots 46 may feature on the spool 30, anywhere around a perimeter. Slits 48 and slots 46 may also provide access of cable 60 from the hollow 34 to the spooling surface 38.

The preferred embodiment features pairings of slits 48 and slots 46, one at each distal end of the spool 30 on one sidewall 42, and a single pairing of a slit 48 and slot 46 in the middle of the opposing sidewall 42, leading to a longitudinal interior perimeter slot 54 between the hollow 34 and the spooling surface 38. These three pairings of slots 46 and slits 48 provides ample functionality for various device-cable assemblies 61, and variation of cable 60 length selection when locking a cable 60 within a slot 46 after spooling or unspooling without being overly redundant in number of slots 64 and slits 48.

Though preferred embodiments feature parallel sidewalls 42 and radii 50, these features may be absent or modified in form in some alternative embodiments.

### Operation:

FIGS. 1 through 6 depicts a first application of a cable spool 30 showing various stages of insertion, spooling and retention of a device-cable assembly 61 comprised of cable 60 and rigid portions 62, shown in the form of an ear-bud assembly with a first cable portion 60A connecting a first ear-bud 62A to a cable assembly joint 62G, a second cable portion 60B connecting a second ear-bud 62A to a volume switch 62B that in turn is connected to the cable assembly joint 62G by a third cable portion 60C. A fourth cable portion 60D connects the cable assembly joint 62G to an audio jack 62C. The term cable 60 is generic for all cable portions 60A, 60B, 60C, and 60D, and any other cable or cable portion referred or implied. The term rigid portion 62 is generic for all devices, plugs, ferrites, electronic housings, or otherwise rigid bodies fixed to cable 60 as part of a device-cable assembly 61, including rigid portions 62A, 62B, 62C, 62D, 62E, 62F, 62G, 62M, 62N, 620, and 62P, and any other rigid body referred or implied.

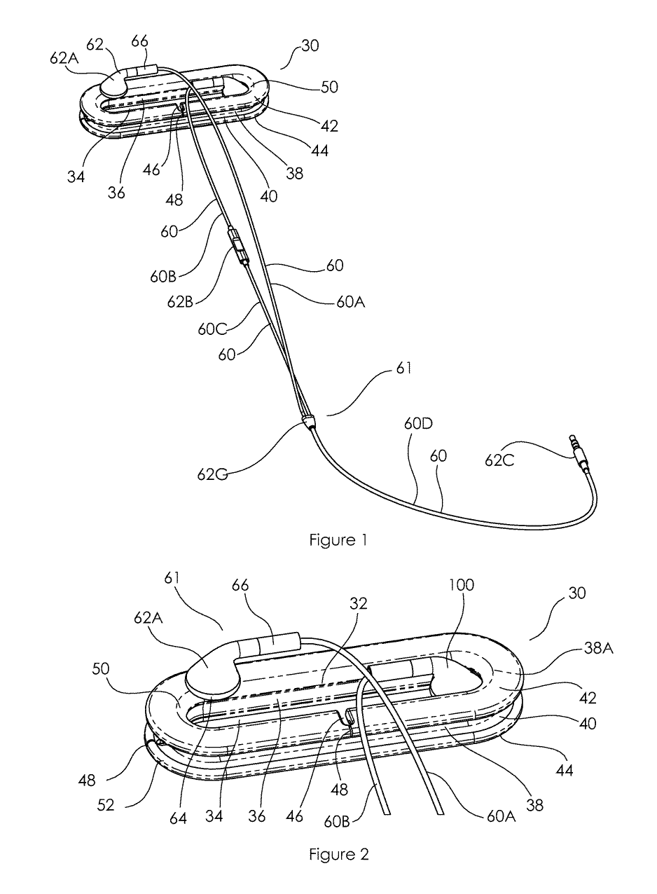

FIGS. 1 and 2 shows a first stage of assembly of a device-cable assembly 61 in the form of an ear-bud speaker assembly, comprised of ear-buds 62A and other rigid portions 62B, 62C, 62G), mounted to cables 60. The left hand side of FIG. 1 shows a first step where an ear-bud 62A is placed proximal to a hollow 34 defined by an interior perimeter 32 of the spool 30, and the right hand side of FIG. 1 shows a second step where an ear-bud 62A is inserted into the hollow 34 comprising a retaining portion for a rigid portion 62 depicted as an ear-bud 62A. A recess 36 forms an undercut around the interior perimeter 32 where the ear-buds 62A may be inserted into where they may be retained, either by being trapped within the undercut of the recess 36 or by friction between the recess 36 and the rigid portion perimeter 64, or both as depicted. The rounded recess end 36A of the hollow 34 permits the nominally round shape of the rigid portion perimeter 64 to fit within it, adding further mechanical retention of the rigid body 62 within the undercut of the recess 34 and further friction with the rigid portion perimeter 64. A radius 50 around the entrance of the hollow 34 defining a transition from a sidewall 42 to a portion of the interior perimeter 32 is disposed to facilitate, like a funnel, the entrance of a rigid portion 62 into the hollow 34 or recess 36. The long, oblong shape of the interior hollow 34 facilities the housing of long rigid portions 62, or portions thereof, such as ear-bud arms 66 that extend from the ear-bud 62A proper.

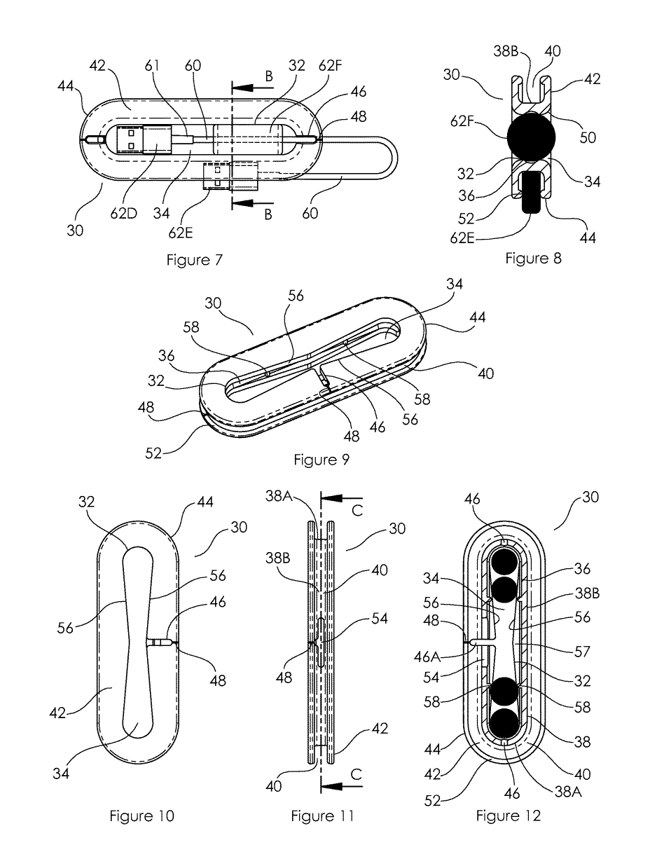

The interior perimeter 32 and recess 36 in the preferred embodiment are deliberately generic and non-specific to the shape of the ear-buds 62A and along the long portions of the recess 36 in the present embodiment to permit the insertion and retention of a variety of rigid portions 62, including a ferrite 62F or proximal plug 62D as seen in FIGS. 7 and 8 and discussed in other parts of this application. A certain degree of flexibility in the material comprising the spool 30 is required to insert the rigid portion 62 into the recess 36, aided by the long linear oblong shape of the spool 30, and being made of elastomeric material in the preferred embodiment.

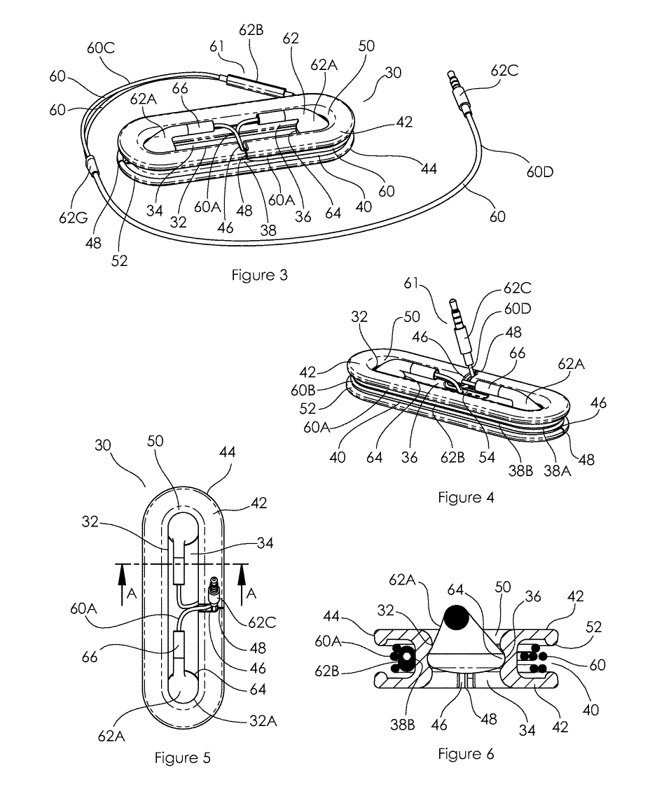

FIG. 3 depicts a third step where cable 60 is inserted through a deformable slit 48 into a slot 46 to allow the cable to pass from rigid portions 62 within the hollow 34 to pass through the material separating the hollow 34 from the spooling surface 38 in a gap 40 defining a spooling cavity. The cable 60 is shown partially spooled around spooling surface 38. From a first ear-bud 62A and a second ear-bud 62A, cable portions 60A and 60B are passed through the slot 46 to a wide interior perimeter slot 54 that allows cable 60 to pass through to the spooling surface unobstructed due to geometric restrictions of the device-cable assembly 61 and spool 30; the long interior perimeter slot 54 allows a large degree of variation of cable 60 location to permit ease of assembly. Cable 60 is shown spooled around a round spooling surface 38A of the spool 60 (the cable 30 concealed by a sidewall 42), providing a large radius relative to the cable diameter to support the cable and prevent kinking the cable. A rigid portion 62, in the form of a volume switch 62B is shown proximal to a long, flat spooling surface 38B portion of the spool 30 where it will come to rest and be supported in a fourth step, as illustrated in FIGS. 4 through 6.

FIGS. 4 through 6 shown views of a fourth step where the cable 60 is completely spooled around the spool 30, where a flat spooling surface 38B portion of the spooling surface 38 provides a means to allow the proper spooling and support of a rigid portion 62, in the form of a volume switch 62B, without straining cable 60 extending from the rigid portion 62 or rigid portion 62 itself as would occur if the rigid portion 62 was supported on a narrow tangential point on a round spool. Cable portions 60A and 60C extend from the volume switch 62B and are shown spooled around to another rigid portion 62 in the form of a cable assembly joint 62G, from which a cable portion 60D is further spooled around the spooling surface 38. The cable 60 is retained within the spool 30 between the sidewalls 42 by passing a distal extremity of the device-cable assembly 61 in the form of a cable 60 through a deformable slit 48 leading to a slot 46 in the sidewall 42 where it is retained therein, the larger rigid portion 62 of the distal plug 62E of the device-cable assembly 61 being prevented from slipping out of the slot 46 by being larger than the slot 46 and slit 48. The distal plug 62E may be placed into the hollow 34 (not shown) with the freedom of access between the slot 46 and the interior perimeter slot 54, allowing for positioning of the distal plug 62E into free space within the hollow 34 and even hooking under rigid portions 62 and cable 60 to further retain it therein, or by friction or mechanical retention at the interior perimeter 32 or within the recess 36, making the assembly even more compact with little or no protuberance exterior of the sidewalls 42 of the spool 30.

The device-cable assembly 61 is considered completely spooled and retained by the spool 30, and is a compact means to organize, spool and transport device-cable assemblies 61 such as those comprised of ear-buds 62A.

FIGS. 7 and 8 show the same first embodiment of a spool 30 as described in reference to FIGS. 1 through 6, however with a different device-cable assembly 61, shown in the form of a USB data cable assembly, such as those used with digital cameras. The device-cable assembly 61 is shown with a proximal plug 62D from which a cable 60 portion extends to a ferrite 62F from which a further cable 60 portion extends to a distal plug 62E, the proximal plug 62D, ferrite 62F, and distal plug 62E comprising rigid portions 62 of the device-cable assembly 61. The proximal plug 62D and ferrite 62F are shown inserted within the hollow 34, the ferrite 62F retained in the recess 36 by the undercut formed within the interior perimeter 32, and supporting the less wide proximal plug 62D therein the hollow 34. Variations of embodiments may feature portion of the interior perimeter 32 and recess 36 to accommodate differing sizes of rigid portions 62 at the same time, as revealed in reference to the second embodiment depicted in FIGS. 9 through 12.

FIGS. 7 depicts slots 36 permitting the passage of cable 60 from the hollow 34 to the gap 40, where it can be spooled around the spooling surface 38. Hidden portions of the device-cable assembly 61 are shown as dotted lines revealing the passage of cable from the ferrite 62F to a distal plug 62E.

The distal plug is shown retained within the gap 40 by portions of the sidewalls 42 referred to as plug retention flanges 52 that effectively place friction on the distal plug 62E and, in some embodiments, a force if the gap 40 between the plug retention flanges 52 is made smaller than the thickness of the rigid body 62 shown as a distal plug 62E, effectively retaining the rigid body 62 between the sidewalls 42 to hold it in place, in a final step of assembly of the device-cable assembly 61 to the spool 30. The plug retention flanges 52, or other portions intended to retain rigid portions 62, may be made from a secondary softer elastomeric material such as gummy or sticky or low durometer elastomer to provide an added means of local material deflection and therefore added force or friction to the rigid body 62.

In such a manner may the spool 30 retain a device-cable assembly 61 in a compact form, with minimum or no protrusion exterior of the sidewalls 42 of the spool 30, depending on the size of the spool 30 relative to the device-cable assembly 61, making the combined assembly of spool 30 and device-cable assembly 61 suitable for compact organization, spooling, storage and transport of a device-cable assembly 61.

### Variations:

FIGS. 9 through 12 depict a second embodiment of a spool 30, featuring wedge-like portions of the interior perimeter 32 allowing a variation in width between interior perimeter 32 sidewalls to accommodate retention of a variety of rigid portion 62 widths, either by friction of mechanical retention such as imposed by an undercut trapping the rigid body 62 within a recess 36. While the wedge feature provides a variation in hollow 34 widths, it is meant to be illustrative of an example of how to vary the width of the hollow 34, however other means of varying hollow 34 width may be accommodated, such as a curved or stepped interior perimeter 32.

The present embodiment features two wedge shaped portions of an interior perimeter 32, each intended to retain a distinct rigid portion 62 of a device-cable assembly 61 within the hollow 34, such as ear-buds 62A (not shown). A rigid portion 62, such as that depicted by a first rigid portion 62M in a first position may freely enter the hollow 34 within the interior perimeter 32 if it is smaller in width than same, and be drawn by a cable 60 (not shown) attached to the rigid portion 62 to a cable exit slot 46A, where the cable 60 is passed through, exiting the hollow 34 where it is afterwards spooled around the spooling surface 38, tensioning and fixing the rigid portion 62 in place against the wedge-shaped interior perimeter 32, as seen by the secondary position of the first rigid portion in position 62N. In embodiments for use with ear-buds 62A, two wedge portions of the interior perimeter 32 narrow toward the center to a centrally disposed cable exit slot 46A, where cable 60 from both ear-buds 62A may be collected and drawn through the cable exit slot 46A together, tensioning both ear-buds 62A equally prior to spooling the cable 60.

A wedge-shape also creates an increasingly greater undercut of the interior perimeter 32 over a recess 36, restricting the exterior movement from the hollow 34 of a rigid portion 62 within the recess 36 once it travels to a narrower portion of the wedge-shaped interior perimeter 32 smaller than the size of the rigid portion 62. A first position of a second rigid portion 62, as depicted in FIG. 12 and identified by 620 and larger than 62M, is shown smaller than the portion of the hollow 34 it is positioned within, such that it may be placed within the hollow 34 without force. A second position of the second rigid portion 62, identified by 62P, is shown to have travelled from the first position to become captive within recess 36 defined by the narrowing wedge of the interior perimeter 32. The present embodiment also shows an alternative width restriction means, other than a wedge, shown as bumps 58 within a recess 36, restricting the movement of a rigid portion 62 within the channel of the hollow 34 from moving past the bumps 58, the bumps 58 making the hollow 34 more narrow, preventing the wider rigid portion 62, depicted as 62P, from passing the bumps 58 as it abuts against them. As a cable 30 (not shown) attached to the rigid portion 62P, the latter comes to rest and be tensioned against the bumps 58, whereafter the cable 60 may pass through the cable exit slot 46A and be spooled around the spooling surface 38, retaining the rigid portion 62P in place against the bumps 58.

What is claimed is:

1. A cable spool to store a device-cable assembly featuring an oblong shaped spooling surface where the cable portion may be spooled around the spooling portion of the spool, wherein an oblong interior perimeter of the spool defining a hollow is disposed to retain a rigid portion of a device-cable assembly.

2. A cable spool, as described in claim 1, with sidewalls extending distally from the spooling surface to retain the cable within a gap between the sidewalls.

3. A cable spool, as described in claim 2, where sidewalls are flat and parallel.

4. A cable spool, as described in claim 1, in which a radius where the interior perimeter connects to a sidewall is disposed to facilitate inserting a rigid portion into the hollow within the spool or an undercut recess around the hollow.

5. A cable spool, as described in claim 1, where a recess at a portion of the interior perimeter provides an undercut cavity to place a rigid portion into, to retain it therein by mechanical means or by friction.

6. A cable spool, as described in claim 1, where the interior perimeter is stadium shaped, with flat sides and rounded ends.

7. A cable spool, as described in claim 1, where the spooling surface is stadium shaped, with a flat spooling surfaces and round spooling surfaces, the flat spooling surfaces providing support for rigid portions of the device-cable assembly, and the round spooling surfaces providing support tor spooling a cable around a directional return at the ends of the spool between the fiat spooling surfaces, preventing kinking of the cable thereupon.

8. A cable spool, as described in claim I, where the distal perimeter is stadium shaped, with rounded ends.

9. A cable spool, as described in claim 1, where the interior perimeter has a wedge-shaped portion to provide a variation in width of the interior hollow to accommodate a variety of rigid portion widths of a device-cable assembly, where a cable portion draws the rigid portion into and against the wedge, where it is retained via friction by tensioning the cable and spooling it around the spooling portion.

10. A cable spool, as described in claim 1, where the interior perimeter has a wedge-shaped portion over a recess to provide a mechanical means to retain a rigid portion of a device-cable assembly, where a cable portion draws the rigid portion interiorly of the wedge, preventing it from being removed exteriorly, where it is retained by tensioning the cable and spooling it around the spooling portion.

11. A cable spool, as described in claim 1, where the interior perimeter has a bump to provide a mechanical means to retain a rigid portion of a device-cable assembly, where a cable portion draws the rigid portion against the bump, where it is retained by tensioning the cable and spooling it around the spooling portion.

12. A cable spool, as described in claim 1, where a plug retention flange is disposed to retain a plug between the sidewalk, of the spool by mechanical force or friction fit to prevent the plug from falling out of the gap, causing the cable to unspool, and without the need for slots to retain the cable.

13. A cable spool, as described in claim 1, where a slit at a distal perimeter in the flexible material of a sidewall is disposed to be deformable to provide access of a cable into a slot.

14. A cable spool, as described in claim 13, where a cable inserted in a slot is considered retained therein, providing a measure of retention to fix the cable in place during spooling or prevent the cable from unspooling.

15. A cable spool, as described in claim 13, where the slot provides a passage for a cable between an interior hollow and a spooling surface on either side of a dividing wall.

16. A cable spool, as described in claim 13, where there is a slit and slot pairing at an end of the oblong spool.

17. A cable spool, as described in claim 13, where there is a slit and slot pairing in the middle of the oblong spool.

18. A cable spool, as described in claim 1, where the material comprising it is elastomeric and locally deformable.

19. A cable spool, as described in claim 1, where the material comprising it is silicone.

20. A cable spool, as described in claim 1, where the material comprising it is thermoplastic.

21. A cable spool, as described in claim 1, where the material comprising it is a thermoset material.

22. A cable spool, as described in claim 1, where the spool is injection molded.

23. A cable spool, as described in claim 1, where the spool is liquid silicone rubber molded.

24. A cable spool, as described in claim 1, where the spool is vacuum casted.

25. A cable spool, as described in claim 1, where the spool is made from a single part.
